(19) United States
(12) Patent Application Publication
(10) Pub. No.: US 2024/0242240 A1
(43) Pub. Date: Jul. 18, 2024

(54) DYNAMIC CONTENT GENERATION AND SELECTION FOR COMMODITY TRANSACTION USER INTERFACES

(71) Applicant: Cargill, Incorporated, Wayzata, MN (US)

(72) Inventors: Amy Bofenkamp, Maple Grove, MN (US); Jeff Klock, Browerville, MN (US); David Matthew Pellinger, Plymouth, MN (US); Zac Patrick Skalko, Minneapolis, MN (US); Kayla Byington, Urbandale, IA (US); Kurt Vander Wiel, Waverly, IA (US)

(21) Appl. No.: 18/559,978

(22) PCT Filed: May 11, 2022
(86) PCT No.: PCT/US2022/028696

§ 371 Date: Nov. 9, 2023

Related U.S. Application Data
(60) Provisional application No. 63/188,534, filed on May 14, 2021.

(51) Int. Cl. G06Q 30/0201; G06Q 40/04

(52) U.S. Cl. CPC G06Q 30/0206; G06Q 40/04

(57) ABSTRACT

Disclosed are data processing systems, user interfaces, application programming interfaces, and related operations for the construction, selection, and display of content relevant to commodity pricing scenarios. In some implementations, a system may obtain pricing values associated with a commodity, and identify (e.g., generate or retrieve) content phrases (e.g., sentences such as comments or interjections) that correspond to the pricing values. The system may determine a relevance weight for each of the identified content phrases, the relevance weight being generated from properties associated with the customer and the respective content phrases. The system may select a subset of the content phrases for output in a user interface, based on the determined relevance weight for the content phrases and rules for output of the content phrases. The system may provide the selected subset of the multiple content phrases to a computing device, for output to the customer in the user interface.

### BACKGROUND

Many types of user interface interactions are performed with producers and other market participants for the sale and marketing of a commodity (e.g., grain such as corn, soybeans, or wheat). For example, a grain producer (e.g., farmer) may utilize a user interface such as a webpage or app regularly to obtain current cash market or futures market prices for a particular class of grain. The grain producer may also access the user interface regularly to obtain pricing information regarding prospective or established contract arrangements tied to some futures market, or to view the details of some commodity delivery or sales arrangement (e.g., a contract established between the producer and a purchaser for delivery or sales of a future crop). A representative from a grain marketer or purchaser may also utilize a user interface for similar reasons, and access a user interface to configure contracts, pricing strategies, and view customer information, in connection with the sales and marketing of the commodity.

Many types of user interfaces, such as webpages and software apps, provide a high-level view of the commodity market and the marketing conditions which is identical for all users. Likewise, many of these user interfaces provide access to high-level market commentary, such as comments on the current state of the market conditions (e.g., a narrative from a trading broker or representative providing commentary on why futures prices moved in a particular direction). As a result, producers may not fully understand how the current market conditions are relevant to their individual business, and how trends in the market information have effects on commodity delivery contracts and pricing strategies.

Thus, challenges remain for obtaining appropriate and timely commodity marketing and pricing information from the perspective of the customer/commodity producer, and for delivering such information from the perspective of the commodity buyer/marketer/trader.

### BRIEF DESCRIPTION OF THE DRAWINGS

FIG. 1 illustrates operation of a content service and related network operations among user interfaces, data services, and platforms, according to an example.

FIG. 2 illustrates a block diagram of data flows and functional components involved with a content service, according to an example.

FIG. 3 illustrates a flowchart of operations for selecting and generating content with a content service, for output within a commodity transaction user interface, according to an example.

FIG. 4 illustrates data inputs used for generating and selecting textual content, for output within a commodity transaction user interface, according to an example.

FIG. 5 illustrates a sequence of customer transactions with a content service, used for output of content within a commodity transaction user interface, according to an example.

FIG. 6 illustrates a flowchart of operations for constructing textual content, for output within a commodity transaction user interface, according to an example.

FIGS. 7A to 7C illustrate data relationships among data values used for construction of textual content, for output within a commodity transaction user interface, according to an example.

FIG. 8 illustrates templates used for construction of textual content, for output within a commodity transaction user interface, according to an example.

FIG. 9 illustrates data rules and values communicated among an engine for construction of textual content, to be output within a commodity transaction user interface, according to an example.

FIG. 10A illustrates a first example of functionality within a commodity transaction user interface, for providing dynamically generated content, according to an example.

FIG. 10B illustrates a second example of functionality within a commodity transaction user interface, for providing dynamically generated content, according to an example.

FIG. 11 illustrates functionality within an administrative user interface for constructing and modifying dynamically generated content, according to an example.

FIG. 12 illustrates a flowchart of a method for dynamic content generation and selection, according to an example.

FIG. 13 illustrates a block diagram of a server and client computing system for implementing the computing and processing techniques discussed herein, according to an example.

FIG. 14 illustrates a block diagram of an example computing machine upon which any one or more of the techniques or methodologies discussed herein may be implemented.

### DETAILED DESCRIPTION

The following provides a description of user interfaces, application programming interfaces, content generation and selection systems, and data processing features used for commodity transaction settings, specifically, related to the sales and marketing of grain commodities. In specific examples, functionality is provided to generate and present relevant and customized information—at appropriate locations and at appropriate times—within a graphical user interface. With access to this information, a commodity producer can understand the content and the context of information in the user interface, make appropriate business decisions, and invoke appropriate user interface actions.

Aspects of content generation and selection (e.g., what content to present) and content positioning (e.g., when and where to present the content) are addressed. The generation of dynamic content, from different “voices” of an intelligent content engine, can provide a mechanism which enables a tailored or unique output of content via suggestions, tips, and commentary. As used herein, such “voices” represent different narrative contexts from the perspective of a user, whether provided with visually output text or spoken text. Digital experiences (whether graphical user interfaces, voice interfaces, messaging, etc.) may leverage the intelligent content engine to drive and influence a user's experience with customized content.

The intelligent content engine, when applied as a “voice engine” for generating and placing narrative content, provides combinations of data elements and sophisticated patterns to generate text sentences that can be inserted strategically within features of a user interface. Additionally, other digital experiences and platforms may leverage the intelligent content engine to drive and influence a user's experience when the right data and input is ingested. For instance, voices may correspond to different narrative contexts and rule sets, such as: Analytics, Facts, Education, Encouragement, and Benchmarking. The use of these different voices to generate custom content, at different places within the digital experience, enables users to obtain relevant content for a variety of commodity price scenarios, with an appropriate contextual overlay.

Also as an example, content generation and selection is provided from analytically-driven text sentences, whose timing, content, and location are customized to a particular target entity (e.g., a grain producer who accesses the user interface) based on weights applied to such content. The customized content may be positioned in the user interface to accompany price quotes and pricing strategies (and, user interface controls that can act on such price quotes and pricing strategies) which are tied to futures, options, delivery contracts, and other financial products and characteristics.

A variety of technical mechanisms are disclosed for the present systems and methods. These include: user interfaces which provide unique representations, arrangements, customizations, and inputs and output choices; client or server computer systems to implement interactive displays and outputs of the user interfaces, including to receive and send data, to perform commands, and invoke functional operations associated with the content generation and selection; cloud services to host and execute instances of application programming instances, to maintain and serve data from operational data stores, to apply rules and specifications for content, and to appropriately invoke other computer systems and data services; and coordination of computer systems (including multiple data sources) to provide a unified view of content; and the like.

Among other features, the technical and real-world benefits of these technical mechanisms includes: improved customization and relevance of output content; improved automation for the presentation of current real-time (e.g., not delayed) market information; improved presentation and customization of data selection mechanisms; performance of multiple data operations and interactive options in real-time or “on-the-fly”, including the automated presentation of pricing strategies and financial information from multiple sources that would not be possible from manual human configuration; and improved accuracy in data operations, leading to reduced rates of error; reduced data retransmission and processing usage, and efficiency.

Various references are made in the following text to commodity prices, contracts, and pricing strategy arrangements. As used herein, a pricing strategy refers to some use of one or more derivatives, contracts, conditions, and contingencies, in connection with the planned, scheduled, or prospective sale or delivery of some commodity. A pricing strategy may be contingent or be linked to certain financial derivatives and market, sale, or delivery conditions. Further, although many of the following examples of content are related to some aspect of pricing or financial data, it will be understood that other relevant content aspects may be generated based on non-financial data, and output or customized based on non-financial triggers.

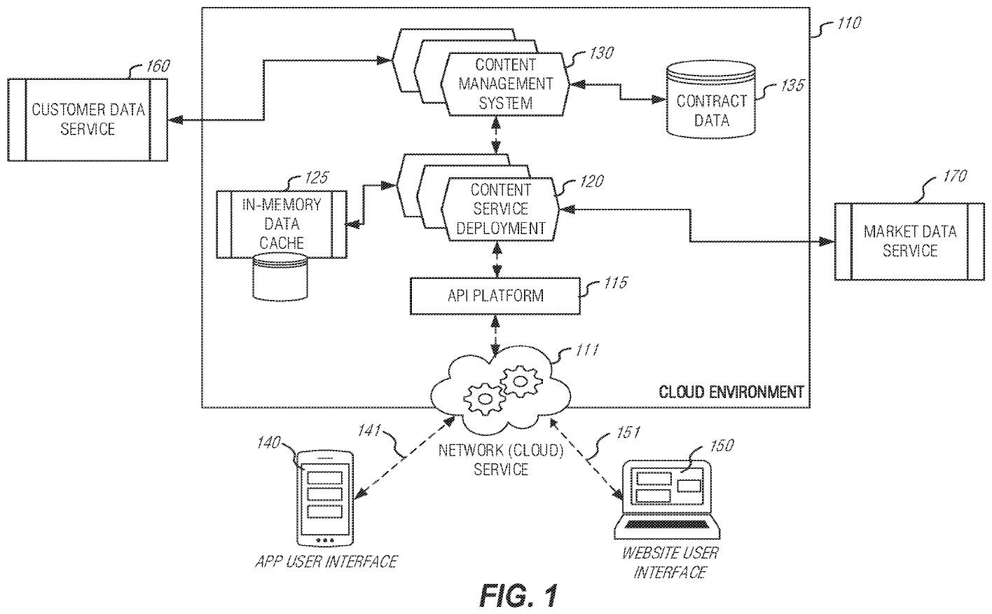

FIG. 1 illustrates an example operation of a content service and related network operations among user interfaces, data services, and platforms. It will be understood that additional computing systems, services, interfaces, communications, and entities may be involved in these scenarios, which are not illustrated in FIG. 1 for purposes of simplicity.

In the depicted example, the cloud environment 110 provides one or more network services 111 (e.g., cloud services), accessible by client user interfaces, such as application user interface 140 and website user interface 150. The cloud environment 110 is provided by one or more computing systems which are responsible for executing software instructions and logic to transmit and receive content with the user interfaces 140, 150 via respective communication links 141, 151. Examples of hardware for such computing systems, and software and interfaces operating within such software instructions and logic, is provided throughout the following description.

In a specific example, the cloud environment 110 provides generated content to the user interfaces 140, 150 that is relevant to commodity pricing, delivery, or sales, such as for grain commodities such as corn, soybeans, wheat, and the like. The generated content itself may discuss aspects of commodity pricing or sales, such as grain cash prices, grain futures contract prices, and prices of related derivatives and pricing strategies. It will be understood, however, that the cloud environment 110 and related systems may provide content for a variety of other types of products, services, and financial derivatives not directly discussed in the following examples.

The content service deployment 120 includes one or more service instances (e.g., virtualized services or instances) which are responsible for executing software instructions and logic to create, update, cancel, and otherwise manage aspects of content generation, selection, and delivery for the user interfaces 140, 150. In an example, the content service deployment 120 generates its content from data retrieved or generated by a content management system 130, as the content service deployment 120 maintains this data with use of an in-memory data cache 125. This in-memory data cache 125 may be substituted with a database or any number of data storage, data warehouse, or data hosting systems and hardware.

The content service deployment 120 may obtain market pricing information from a market data service 170. For example, such pricing information may include current futures contracts prices, option contracts prices, and market prices, bid prices, ask prices, transaction information, and related information. For instance, such pricing information may include commodity futures prices or options prices from commodity markets such as the Chicago Mercantile Exchange, Chicago Board of Trade, New York Mercantile Exchange, Minneapolis Grain Exchange, Kansas City Board of Trade, among others; or, cash prices based on such commodity market prices.

The content management system 130 may provide pre-populated or dynamically generated content for use with the content service deployment 120. The content management system 130 may determine which content to serve or generate on the basis of information from a customer data service 160, and contract data associated with a particular customer. Such contract data may be maintained in a contract data store 135, which may be provided by a database or any number of data storage, data warehouse, or data hosting systems and hardware.

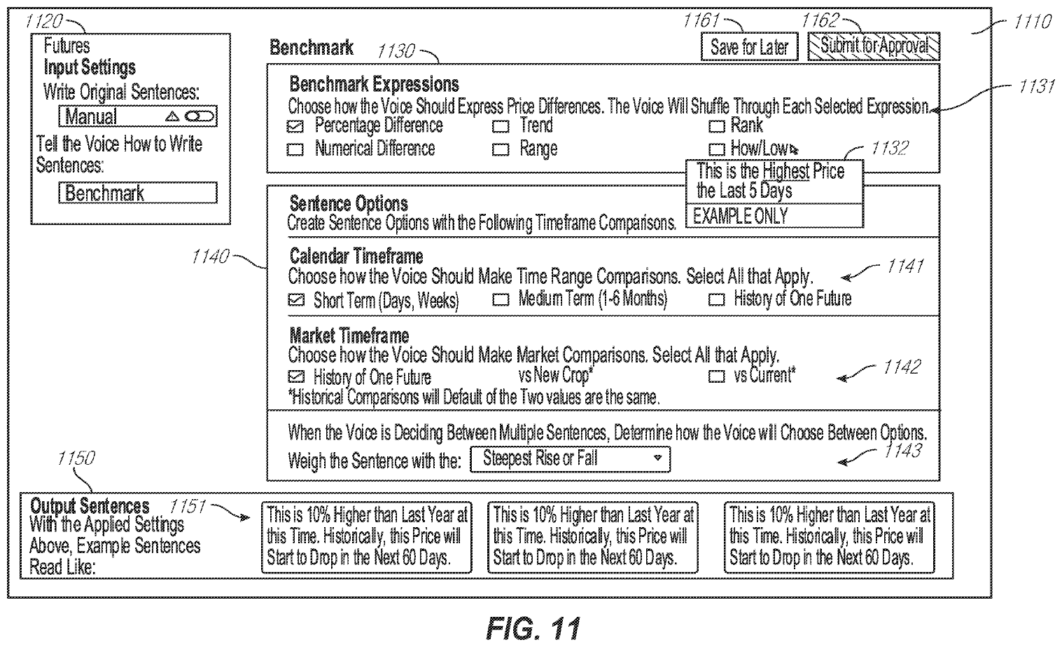

The presently disclosed user interfaces, such as those discussed below, may be hosted or facilitated through the cloud service 111. As an example, user interfaces may be provided via a web site hosted at the cloud service 111, as respective client computers access a website user interface 150 served from the cloud service 111. Such access between the website user interface 150 and the cloud service 111 may be provided in a synchronous or asynchronous manner via communication link 151. As another example, the user interfaces may be provided via an app user interface 140 provided in a software application (app) that is installed on a client computing device such as a smartphone, as respective smartphones install the app user interface 140 and access data via one or more application programming interfaces (APIs) 115 of the cloud service 111. Likewise, the access between the app user interface 140 and the cloud service 111 may be provided in a synchronous or asynchronous manner via communication link 141. Other forms or types of dynamic and distributed user interfaces, including those which distribute features among the client and server, are also possible. Such user interfaces may include functionality or limitations that is specific to customers (e.g., commodity producers such as farmers), or salespersons (e.g., brokers, customer account managers, traders, etc.), administrators, or other relevant entities. Specific aspects of an administrative user interface is discussed in relation to FIG. 11, below.

The following examples specifically focus on the generation, selection, and delivery of textual content related to commodity pricing information. It will be understood that pricing information is not limited to market prices (e.g., cash or futures prices), but may include other aspects of sales and delivery contracts (including fees, charges, rates) and associated financial instruments and derivatives (such as futures contracts, options contracts, etc.). Thus, pricing information may be used to display characteristics of broad features from overall “pricing strategies”, whether used for sales, hedging, or speculative purposes. Other aspects of contract data and customer data may also be considered.

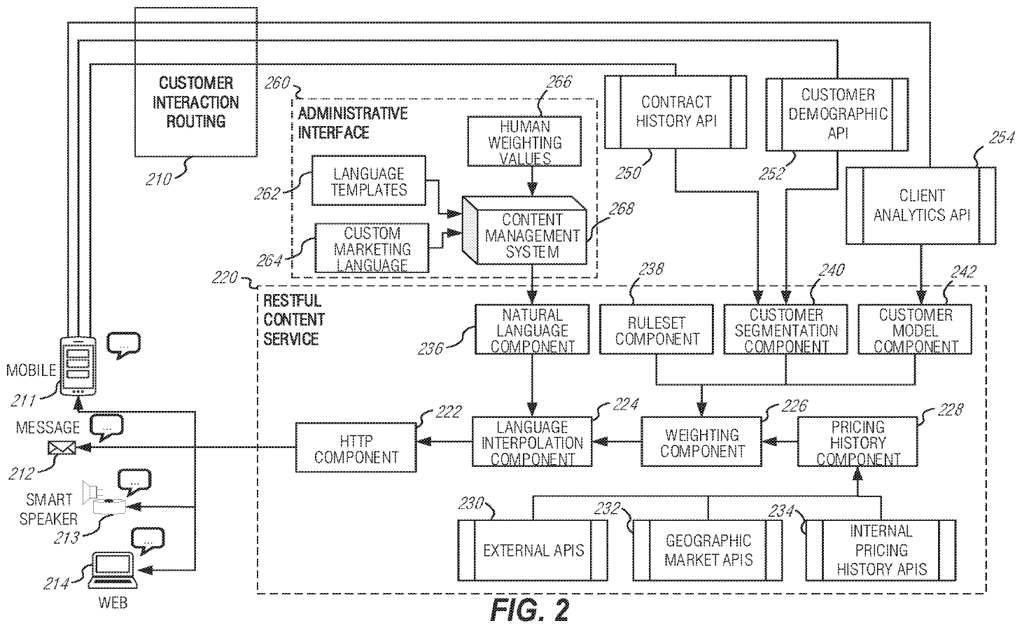

FIG. 2 illustrates a block diagram of data flows and functional components involved with a content service. Here, a RESTful content service 220 (i.e., operating with a Representational State Transfer (REST) web service) provides content via an HTTP component 222, to devices such as a mobile device 211, messaging devices 212, smart speaker 213, web browser 214, etc. The user interfaces discussed herein may be provided among any of these mediums or channels. The RESTful content service 220 in this example operates a service with a stateless architectural style; however, other stateless and stateful service forms may also be used.

The RESTful content service 220 generates and selects textual content based on interaction among a number of components. A language interpolation component 224 operates to insert content (e.g., text) into a user interface based on weights created and applied from a weighting component 226 and language features (e.g., templates, rules, etc.) established from a natural language component 236.

The natural language component 236 provides natural language content based on data (text, rules, templates, etc.) from a content management system instance 268. The content management system instance 268 may be controlled within an administrative interface 260 or service instance which provides the ability for an administrator to provide (e.g., add, change, remove, invoke) language templates 262, custom marketing language 264, and human-provided content weighting values 266. The content management system instance 268 may provide an implementation of the content management system 130.

In an example, a number of candidate natural language phrases (content phrases) are provided by the natural language component 236 for use in a user interface, and such phrases are weighted with use of a weighting component 226. For instance, each candidate natural language phrase may have a weight calculated for the phrase (e.g., calculated in the range from 0.0 to 1.0). The weight may be based on a combination of: rules applied from a ruleset component 238, segmentation relevance values determined from a customer segmentation component 240, customer relevance values determined from a customer model component 242, and pricing history relevance values determined from a pricing history component 228. The pricing data sources used by the pricing history component 228 may include external APIs 230, geographic market APIs 232, or internal pricing history APIs 234.

In an example, customer interactions that occur with the user interfaces provided with the devices 211, 212, 213, 214 are tracked using a customer interaction routing component 210. Such customer interactions may be recorded in data that is accessible via a contract history API 250, a customer demographic API 252, a client analytics API 254, or other APIs or related systems and data stores (including those discussed with reference to FIG. 1). The APIs 250, 252 provide content which may be consumed by the customer segmentation component 240, and the API 254 provides content which may be consumed by the customer model component 242.

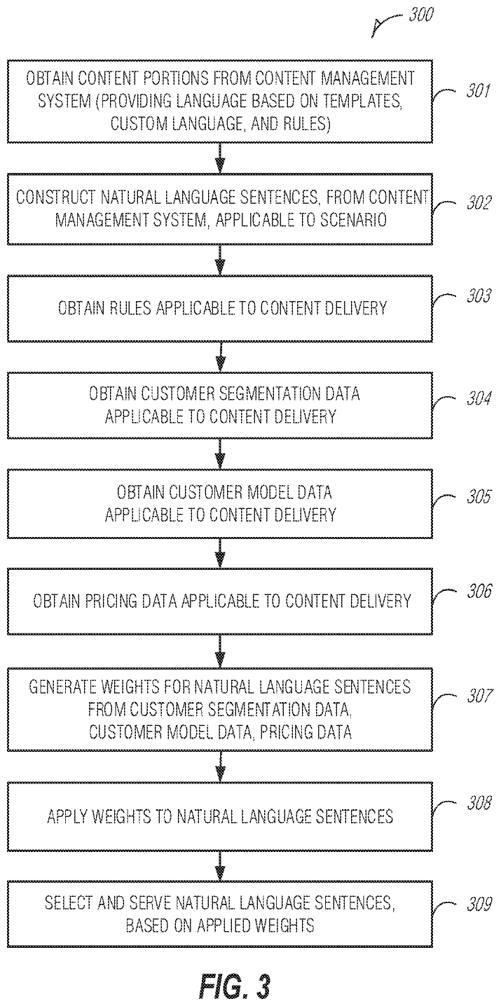

FIG. 3 illustrates a flowchart of example operations 300 for selecting and generating content with a content service, for output within a commodity transaction user interface. These flowcharts provide more detail on the functional operations enabled by user interaction with the user interfaces 140, 150, as operations are performed with the administrative interface 260 and the RESTful content service 220.

The operations 300 are structured from the perspective of data transactions that are performed within the RESTful content service 220 to select and generate content for a producer, customer, broker, or other user interface client/user. However, it will be understood that other intermediate actors or systems (and, many other data values and transactions) may also be involved. The flowchart of the operations 300 for selecting and generating content includes the following sequence:

At operation 301, content portions (e.g., text segments, clauses, fragments, or whole or partial pieces used to construct language sentences) are obtained from a content management system (e.g., the content management system instance 268). The content management system provides the content portions based on templates, custom language, and rules, among other examples.

At operation 302, natural language sentences that are applicable to a user interface scenario are constructed or arranged, from the content portions (e.g., the portions of content obtained from the content management system). As used herein, a sentence generally refers to a set of words that is generally complete by itself and can be output to a user, whether in the form of an interjection or comment. A sentence is constructed from one or more content portions. As also used herein, a “content phrase” refers to one or more sentences which are constructed to be output in connection which some particular content (e.g., commodity prices or attributes).

At operations 303-306, data relevant to content delivery in the user interface is obtained, to be used in weighting. This data may include: at operation 303, obtaining rules applicable to content delivery; at operation 304, obtaining customer segmentation data applicable to content delivery; at operation 305, obtaining customer model data applicable to content delivery; and at operation 306, obtaining pricing data applicable to content delivery.

At operation 307, weights for use of the natural language sentences are generated, based on the obtained data (e.g., based on the customer segmentation data, customer model data, pricing data), and application of the content delivery rules. At operation 308, the weights are applied to each of the natural language sentences.

At operation 309, the natural language sentences are selected and served in the user interface, based on the weights are applied to each of the natural language sentences.

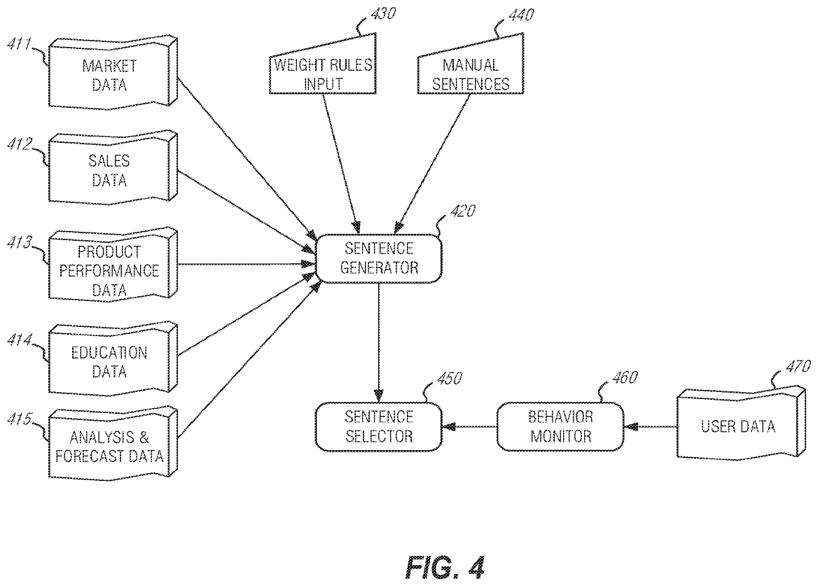

FIG. 4 illustrates example data inputs used for generating and selecting textual content, for output within a commodity transaction user interface. This drawing and the following paragraphs refer to the types and categories of data (content portions) that are used to generate and select textual content (sentences), which is then provided as one or more customized sentences for output in user interfaces. Other audiovisual forms of content may be generated and selected.

A sentence generator 420 operates to determine candidate content (e.g., candidate sentences) for a user interface based on combination of one or more data sources: market data 411 (e.g., data associated with a commodity action in a public commodity market); sales data 412 (e.g., data associated with commodity purchases or transactions, in a private company or private market); product performance data 413 (e.g., data metrics associated with the performance of a particular pricing strategy associated with a commodity); education data 414 (e.g., data which provides educational content related to a pricing strategy, commodity, market condition, etc.); analysis and forecast data 415 (e.g., data related to a forecast of a market condition, commodity price, etc.)

To generate candidate sentences, the sentence generator 420 considers weight rules input 430 (e.g., rules which define how weights are to be applied to sentences) and manual sentences 440 (e.g. manually crafted or curated text sentences or portions of text sentences). The sentence generator 420 provides the candidate sentences to a sentence selector 450, which selects sentences for output in the user interface based on applied weights.

Each type of input data may have specific business rules to generate meaningful context. For example, the market data 411 may have different rules applied from the rules input based on the administrator input. Additionally, an administrator user can use the manual sentences 440 to override what the system has generated (e.g., if there is a specific weather event that will likely impact a specific market and no historical data matches what is predicted to happen). Data 411, 412, 413, 414, 415 can each be tuned via an administrator interface (exposed or associated with the rules input 430).

The applied weights or the selection or positioning of particular sentences in a user interface may be further influenced by a behavior monitor 460. The behavior monitor 460 may identify user behaviors based on user data 470 (e.g., historical user data). Further discussion of how weights are determined and applied to different text portions are provided in the examples below.

As an example, the sentence generator 420 may be used to create a candidate list of sentences, each with a weight score (0-1) derived from business rules input of the weight rules input 430. The sentence selector 450 then applies weight filters based on the user data 470. Each user has a personalized filter on the base weights as generated by the sentence generator 420 that is influenced by the user's behavior (e.g., conversions, time spent in app, sales history, etc.).

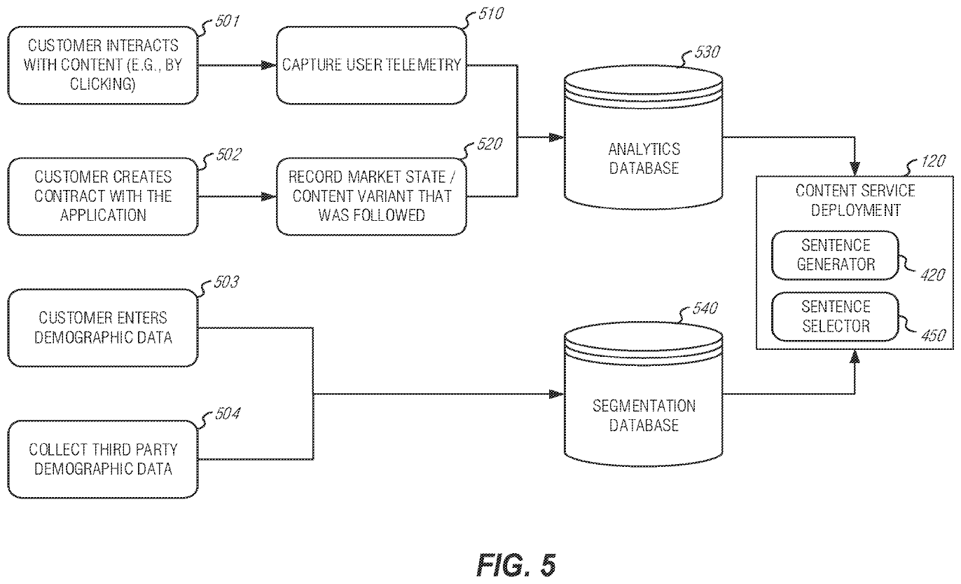

FIG. 5 illustrates a sequence of example customer transactions producing data for a content service, for a content service used for outputting content within a commodity transaction user interface. Here, data from a number of customer transactions are recorded and used for analytics and segmentation purposes, to further enhance a content generation, weighting, selection, and placement.

A first customer transaction is shown in operation 501, where a customer interacts with content in a user interface, such as by clicking a user interface control (e.g., button or link) which is associated with some financial data value. From this customer interaction, user telemetry may be captured at operation 510. Telemetry values associated with a customer may be recorded in an analytics database 530. This user telemetry represents the detailed metrics of a user's interaction with the user interface or the application providing the user interface. Examples of user telemetry represented by these values include, daily uses of the user interface or application; time spent per use; user interface views that the customer spends the most time on; the amount of time spent viewing a price until creating a contract; and the like.

A second customer transaction is shown in operation 502, where a customer creates a contract (e.g., commodity delivery contract) using a user interface and underlying applications. The relevant market information and content variant that was presented, at the time that the contract was activated (and a user interface action was followed), is recorded in operation 520. The contract and market details, and other aspects of the transaction, may be recorded in the analytics database 530.

A third customer transaction is shown in operation 503, where a customer uses a user interface to enter or modify demographic data. The demographic data may be recorded in a segmentation database 540 which includes data for a plurality of customers, and which is subsequently used for content selection purposes to help match the customer with content relevant to a customer segmentation.

A fourth customer transaction is shown in operation 504, where third party demographic data is collected or updated for the customer. This demographic data also may be recorded in the segmentation database 540, and subsequently used for content selection purposes to help match the customer with content relevant to the customer segmentation.

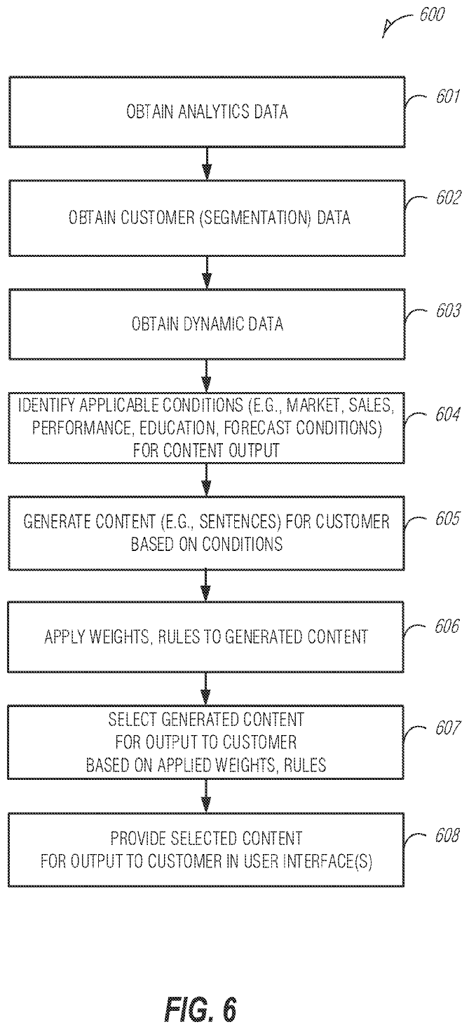

FIG. 6 illustrates a flowchart of example method 600 for constructing textual content, for output within a commodity transaction user interface. This flowchart provides more detail on the functional operations enabled by a voice engine (e.g., a content service deployment which specifically generates comment or interjection sentences, for visual text or spoken word output), implementing aspects of the sentence generator 420 and sentence selector 450. However, other components or entities may also be involved with the following operations.

At operation 601, analytics data is obtained (e.g., from the analytics database 530), and at operation 602, customer data related to segmentation is obtained (e.g., from the segmentation database 540). Such analytics and customer data may be used to determine the relevance of particular content to the customer (or other entity) who will be provided the content in the user interface.

At operation 603, dynamic data is obtained. This may include real-time market data related to the pricing of some commodity (e.g., cash price or futures price), or a commodity financial product or pricing strategy associated with the commodity.

At operation 604, applicable conditions are identified to produce an output of content. These conditions may be identified from the market data 411, sales data 412, product performance data 413, education data 414, and analysis and forecast data 415, or similar data sources. At operation 605, specific content such as text sentences is generated, based on the applicable conditions and the information provided from data sources 411, 412, 413, 414, 415.

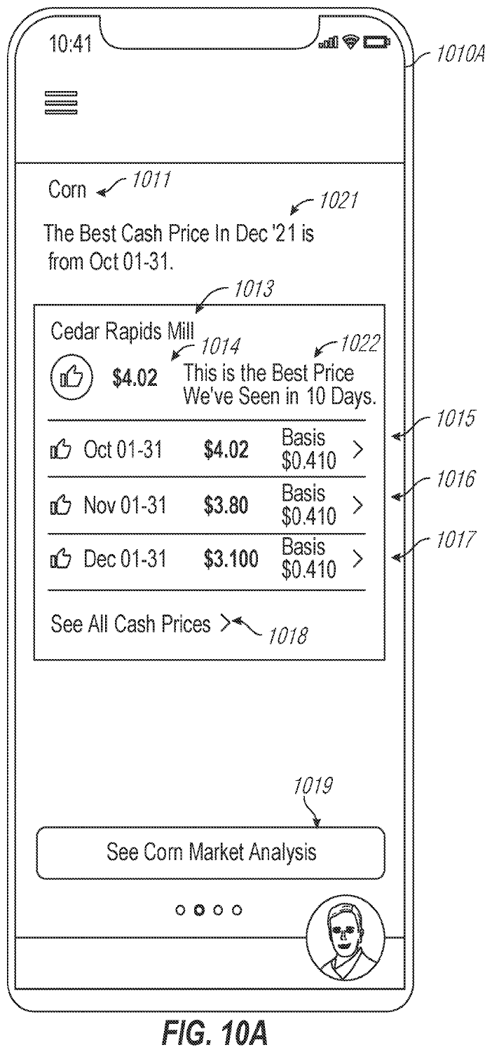

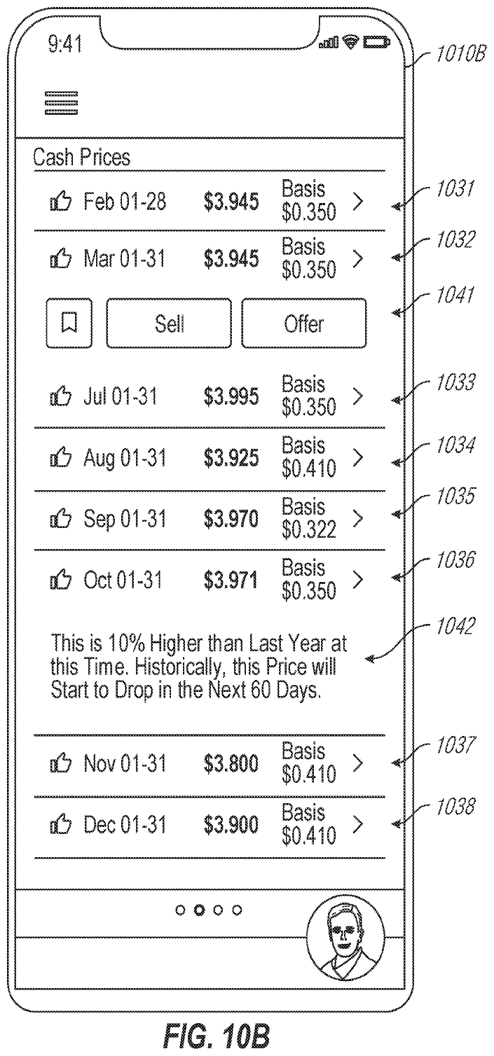

At operation 606, weights and rules are applied to the generated content, to determine which content can (and cannot) be displayed to customers. Such weights and rules are also used to determine where to display the generated content (such as rules for selecting n locations for output in the user interface, based on the n highest weighted text sentences). Further, when selecting from a list of prices to comment on, a limited number of sentences are displayed to prevent the user from seeing an excess of textual data. This is shown in more detail with commentary message 1042, provided in FIG. 10B, discussed below. In FIG. 10B, a slot for commentary on each pricing quote 1031-1038 may have a generated sentence; however, a user-defined limit or rule is applied to determine how many items to present to the user (in this illustration, only one item).

At operation 607, the generated content is selected for output to a particular customer, based on the applied weights and rules. This selection may also apply rules and weights-such as by selecting only particular types of content, which match the rules, and which have relative or absolute weights exceeding a particular value. At operation 608, the selected content is provided for output to a customer in one or more user interfaces.

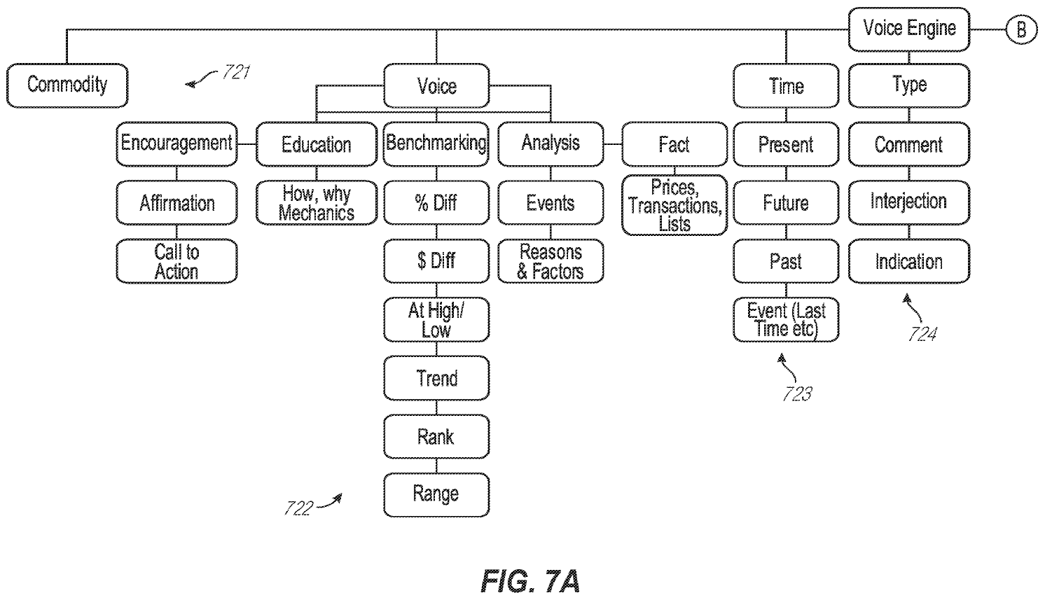

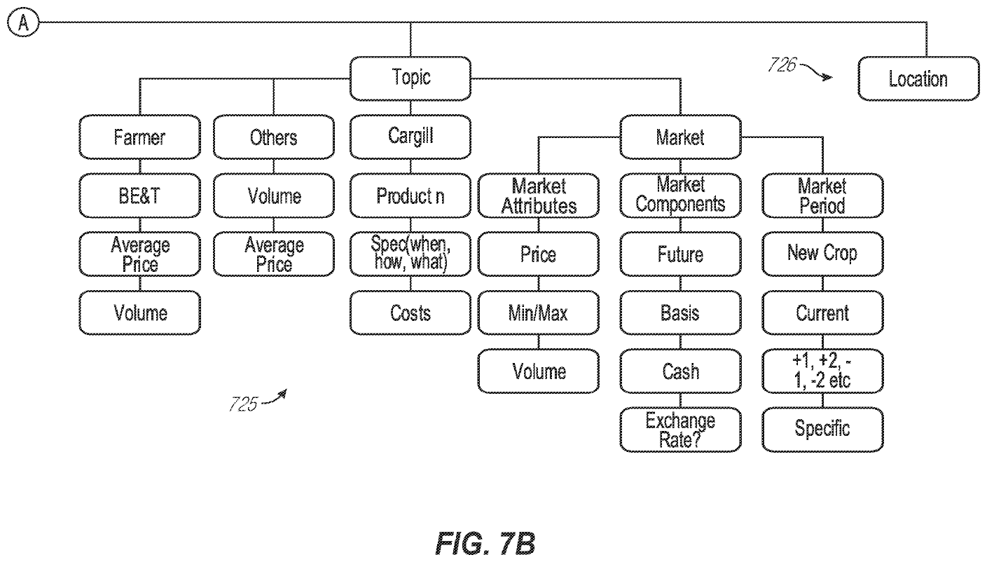

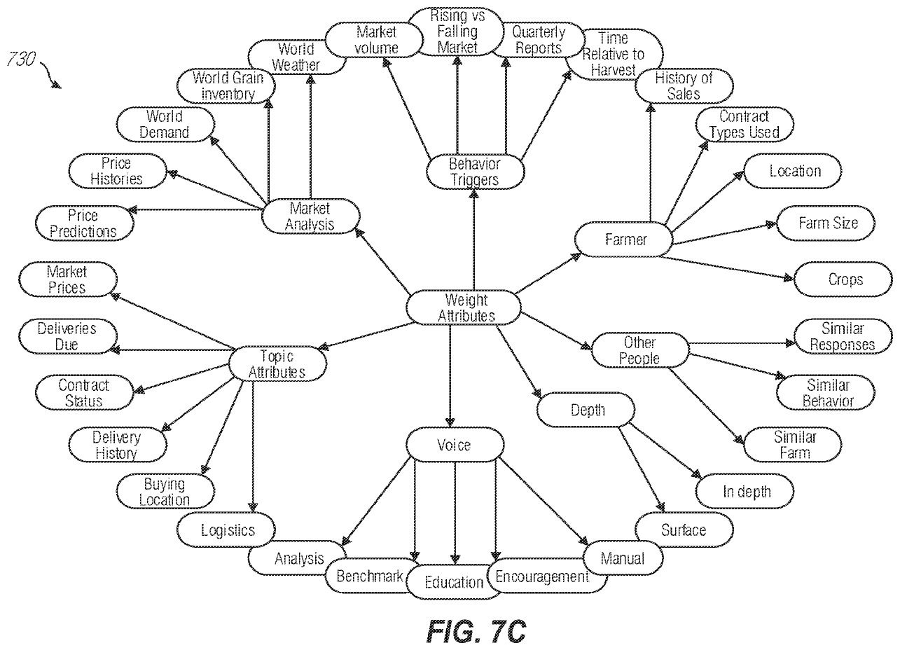

FIGS. 7A to 7C illustrate example data relationships among data values used for construction of textual content, for output within a commodity transaction user interface. Expanding on the previous examples of sentence generation and selection, the following discusses ways in which portions of a text sentences may be constructed, selected, and weighted from different attributes, within a voice engine.

FIGS. 7A and 7B more specifically depict the compositional attributes of sentences, constructed by a voice engine, for use in a grain marketing domain. Other attributes would exist to tailor sentences to different high-level subjects, for instance, for use in contracting strategies. A typical commodity pricing sentence will need to consider or use at least one attribute from each category (e.g., commodity category 721, voice category 722, time category 723, type category 724, topic category 725, and location category 726).

Consideration of the context of the sentence may satisfy one or more attributes. For example, a sentence on a page dedicated to the commodity of corn may not need to express the commodity attribute directly, as it is implied by the context. (Examples of such interfaces that are dedicated to a particular commodity are shown in FIG. 10A).

Commodity category 721 may include values associated with the particular commodity (e.g., data values specific to corn); and location category 726 may include values associated with a particular location or area (e.g., data values specific to the location of a customer).

Voice category 722 may include attributes related to which voice (narrative type) should be used to construct sentences, such as encouragement, education, benchmarking, analysis, or facts (e.g., prices, transactions, lists).

Time category 723 may include attributes related to time properties (such as present, future, past) or referencing the timing of events (e.g., last time this event happened).

Type category 724 may include attributes related to how the constructed sentences will interact with other existing content (e.g., comment, interjection, indication).

Topic category 725 may include topics related to: a farmer (e.g., the farmer's break even and target prices (BE&T), average price received, or volume sold); the commodities market (e.g., market attributes such as price, volume, min/max; market components such as futures, basis, cash prices, and exchange rate as applicable; market period such as new crop, current crop, periods bracketing the current period, or a specifically identified period).

Other attributes and categories not depicted in FIGS. 7A and 7B may be provided.

FIG. 7C depicts a number of factors 730 that may be considered as part of final weighting for the voice engine content. FIG. 7C specifically shows more detail as to the attributes considered by the weighting component 226 or operations 307, 606 of the weighting engine. Final weight values of a created expression will be derived from a wide variety of sources.

One type of weight attribute, behavior triggers, give value to a specific customer's previous behavior during various market conditions or events such as market volume, rising versus falling market, quarterly reports, and time relative to harvest.

Another type of weight attribute, market analysis, are associated with known effects of past market conditions on a customer's perception of marketing strategy, with features such as world weather, world grain inventory, world demand, price histories, and price predictions.

Another type of weight attribute, topic attributes, are associated with the user interface's topical context (e.g., provided via a software app, web page, or other delivery method). Topical context cues include content such as a page speaking of market prices, deliveries due, contract status, delivery history, or buying location.

Another type of weight attribute, voice, is associated with which voice is known to have more impact on a specific user, context, topic or time. Voice weightings may include categories such as analysis, benchmark, education, encouragement, or manual attributes.

Another type of weight attribute, depth, is associated with the depth context of the delivery application or webpage. In some cases generalized or “surface” comments will receive more weight, and in others more in depth comments will score higher.

Another type of weight attribute, other people, is associated with similar responses, similar behavior, or similar farm attributes. The positive reaction of other people with these “sameness” attributes will contribute to sentence weight for a given sentence.

Another type of weight attribute, farmer, is associated with the user's history of sales, contract types used, location, farm size, and crops.

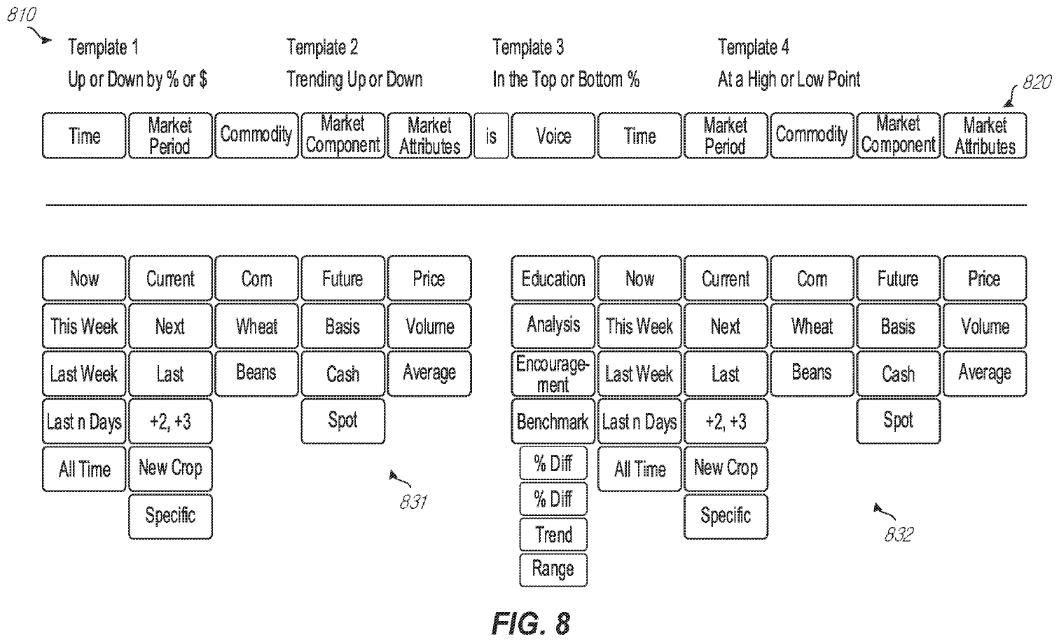

FIG. 8 illustrates the underlying templates used for construction of textual content, for output within a commodity transaction user interface, according to an example. Here, these templates show how a defined data structure (e.g., detailed in FIGS. 7A and 7B) can be used to by a voice engine to create various sentence templates that construct many types of sentences, as the voice engine employs the language rules to create an inventory of possible sentences. Those sentences are combined with the weighting module and weighting properties (e.g., detailed in FIG. 7C) as the voice engine decides which sentence to place in a given location.

As shown, a set of example templates 810 are used to trigger the generation of a voice output, using a set of conditions and attributes 820. For instance, a first template may be provided based on whether the market is up or down by a certain percentage or dollar amount. A second template may be provided based on whether the market price is trending up or down. A third template may be provided based on whether the market price is in the top or bottom percentage. A fourth template may be provided based on whether the market price is at a high or low point.

Based on the template, an inventory of content may be accessed. A number of possible values exists that may fill any given location in this template. The Time attribute, for example, could be filled by: now, this week, last week, last n days. Also, the Market Period attribute could be filled by current period, a bracketed period (next period, last period, +/−2 or more periods), the new crop period, or any specifically named period. Similar values could be provided for each attribute in the sentence template. From this data, a large number of rough sentences can be created for the weighting engine to evaluate.

As an example of the use of the inventory of content, the following conditions may be evaluated to trigger content output:

1) Now current corn future price <is> 15% above last week current corn future average.

2) Now current corn future price <is> 7% above last week current corn future high.

3) Now next corn future price <is> 7% above now current corn future high.

4) This week current future average <is> 12% above this year current corn future average.

An example of the rules applied by the voice engine, to override the display of the content, includes:

RULE: If time=now then time is silent.

RULE: If page filtered to commodity then commodity is silent.

RULE: If time=now then market attribute=price

RULE: If market component on left=market component on right, then right is silent.

For example, application of the following conditions may provide the following voice engine output, to be inserted in the user interface:

1) March future is 15% above last week.

2) March future is 7% above last week's high.

3) June future is 8% above March.

4) This week's March future is 12% above this year's average.

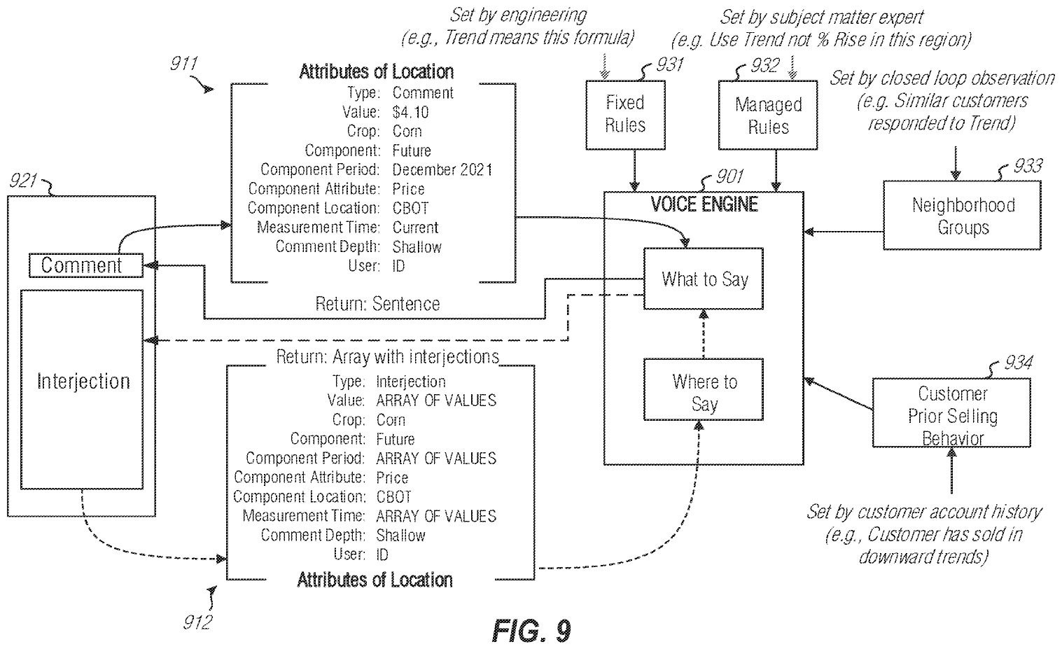

FIG. 9 illustrates communications used by a user interface component (e.g., a specific item or location in an app, web page, smart speaker) to request a sentence relevant to that context. Specifically the user interface 921 would supply the voice engine 901 with contextual metadata 911 relevant for the sentence that should be returned by the voice engine. The voice engine 901 will return either a stand-alone sentence for the user interface to place or an array of values with one or more sentences interjected that adds commentary to those values. With this configuration, a voice engine 901 instance is configured to produce textual content on the basis of various rules, behaviors, and data inputs, to determine what to say (the composition of the textual content) and where to say it (the timing and manner of presenting of the textual content).

Here, a data flow is provided from a user interface 921, which enables the presentation of textual content in various locations of the user interface 921 as one or more comments and one or more interjections. Comments and interjections are both types of voices but can produce the same or similar output. In some examples, a client application may inform the voice engine 901 whether it wants to obtain a comment (a defined response with a single input) or an interjection (a response that may or may not return one or more voices based on an array of inputs).

In the depicted example, the content for such comments are produced based on example contextual metadata 911, and the content for such interjections are produced based on example contextual metadata 912. As this diagram notes, if a meta-data Type is set to ‘comment’, the voice engine 901 returns a sentence built specifically for the location that generated the request. If, on the other hand, Type is set to “Interjection”, the voice engine 901 expects to receive an array of possible sentence locations and is instructed to determine a sentence and the specific location (by sentence weighting) that is best served by that sentence.

This data flow also demonstrates the example types of context information (for the user interface location) communicated within the example contextual metadata 911, 912, such as information related to the size of the user interface location, the type of financial value associated with the location, and the like. The user interface 921 uses these attributes to inform the voice engine 901 about the context of the user interface location, so that the voice engine 901 can determine what content to say. The voice engine 901 mixes this context information with information from other sources, such as rules (e.g., fixed rules 931 and managed rules 932), groups (e.g., effectiveness of sentences on users similar to this one, provided by neighborhood group information 933), and customer's past behavior (e.g., past selling behavior information 934 in selling the commodity).

A variety of rules may be implemented by the voice engine 901. For instance, fixed rules 931 may be set by an administrator (e.g., engineering team), such as to define a rule that some particular trend will apply a particular formula. Also for instance, the managed rules 932 may be set by an administrator (e.g., subject matter expert), such as to define a temporary rule during a particular market condition or a regional rules such as emphasizing cash prices in one region and basis prices in another.

The neighborhood group information 933 may be established from closed loop observation, such as to identify how similar customers responded to the identified trend. In this case, similarity for “neighborhood” group members can be tied to customers with similar farm size, similar time based selling patterns such as making futures contracts in the spring, similar site analytics such as time spent per session, or similar reaction to calls to action within the user interface. The past selling behavior information 934 may be established from account history of the particular customer, such as information which indicates whether the customer has or has not sold in similar market trends.

FIG. 10A illustrates a first example of functionality, within an example commodity transaction user interface 1010A, for providing dynamically generated content. Here, a commodity screen to display pricing information for a commodity 1011 (Corn) includes a pricing list 1013, a series of pricing quotes 1015, 1016, 1017 (e.g., cash prices at a designated location), and user interface functionality 1018, 1019 to interact with additional pricing quotes (e.g., a selection link to see all cash prices) and market analysis.

The user interface 1010A includes two dynamically generated content portions which are inserted: a first content message 1021 (displayed at the top of the screen), and a second content message 1022 (displayed next to a pricing quote 1014). These messages 1021, 1022 may be constructed based on the conditions and rules discussed above (e.g., for the voice engine 901); both sentences represent typical examples of the “Comment” placement type. In these examples, the user interface details the context of the location (e.g., contextual metadata 911) and the voice engine (e.g., the voice engine 901) provides a sentence relevant to that location. Accordingly, the client application may provide a list of possible entry points, and the voice engine can select which of these entry points to respond to, based on the weights of the potential voices for each of these entry points.

FIG. 10B illustrates a second example of functionality, within a commodity transaction user interface 1010B, for providing dynamically generated content. Here, a more detailed listing of pricing quotes are provided, including a series of pricing quotes 1031, 1032, 1033, 1034, 1035, 1036, 1037, 1038. This figure shows a typical example of the “Interjection” placement type. In this case the user interface 1010B supplies the whole list of prices to the voice engine (e.g., the voice engine 901), and the voice engine chooses both the best location and the most effective sentence (e.g. based on contextual metadata 912).

The user interface 1010B includes a set of selection options 1041 (e.g., options to save, sell, or generate an offer for a particular pricing), and a commentary message 1042 displayed for a particular price value (e.g., price quote 1036). The commentary message 1042 is dynamically generated by the voice engine based on the scripted messages discussed above. The commentary message 1042 is dynamically selected for display at a location associated with the price quote 1036 (and, other messages are not shown for other price quotes) based on the weighting established for the message 1042. Other candidate messages (commentary and interjections) having lower weights will not be displayed.

It will be understood that a graphical user interface usable with the present approaches may include less, more, or different functionality, and that the user interface 1010A, 1010B are provided only for purposes of example and illustration.

FIG. 11 illustrates functionality within an example administrative user interface 1110 for constructing and modifying dynamically generated content. For instance, a number of customizations and settings may be applied based on the data attributes (e.g., discussed in relation to FIGS. 7A to 7C and by the managed rules 932 discussed in relation to FIG. 9). The following aspects of the administrative user interface 1110 are refer to ways in which sentences are created from specific time and market conditions; settings for other conditions and scenarios may be adjusted.

The administrative user interface 1110 includes input settings 1120 which may designate ways in which output sentences are constructed. For example, different styles may be used to construct sentences, such as a “Benchmark” style, an “Education” style, an “Analysis” style, or an “Encouragement” style. Additionally manual styles or sentences may be constructed.

The administrative user interface 1110 includes sentence options values 1130, which specify how sentences are constructed. Specifically, certain characteristics of benchmark voices 1131 are specified, including settings relating to whether an expression can include percentage difference, numerical differences, trends, ranges, ranges, etc. Various examples of such sentence constructions also may be displayed (e.g., via tooltip 1132).

The administrative user interface 1110 includes sentence options values 1140, which may provide: calendar settings 1141; market settings 1142; and selection settings 1143. In particular, the selection settings 1143 may provide ways in which weights may be manually adjusted (e.g., by increasing the weight on a particular type or form of content).

The administrative user interface 1110 may also include an output section 1150, which displays examples 1151 of one or more output sentences to be constructed. Finally, the administrative user interface 1110 includes user controls 1161, 1162 (e.g., buttons) which allow settings to be saved or implemented.

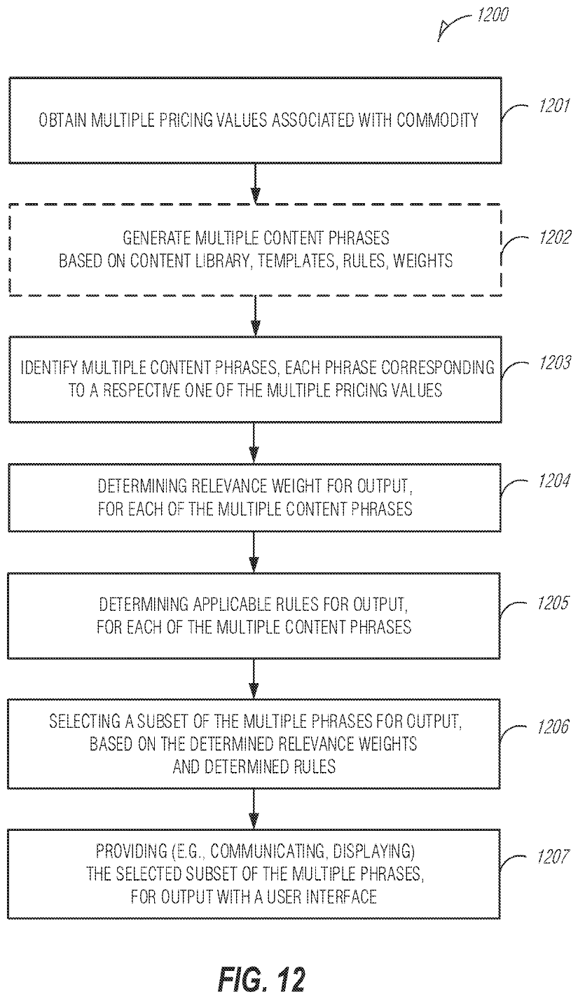

FIG. 12 illustrates a flowchart of an example computer-implemented method 1200 performed by a computing system for dynamically generating and selecting content associated with a commodity, for output in a user interface. It will be understood that the following method 1200 may be implemented by a computing system, computer-readable storage medium having instructions to configure a computing system, and other systems and devices discussed herein.

Operation 1201 begins with obtaining multiple pricing values associated with a commodity, with such pricing values being obtained from one or more sources (e.g., market data sources). In an example, the multiple pricing values are associated with respective expiration or execution dates associated with at least one of a cash price, a futures contract price, an options contract price, a delivery contract price, or a pricing strategy price, for the commodity. Also in an example, the commodity is an agricultural commodity provided from among: corn, soybeans, wheat, barley, rice, oats, oilseeds, cocoa, cotton, coffee, sugar, or products thereof. Other types of commodities and pricing values may also be considered or used.

Operation 1202 includes optionally generating multiple content phrases (e.g., sentences), such as with the sentence generator and related generation techniques discussed above. These operations may include generating the multiple content phrases from a combination of text portions, with the text portions corresponding to pieces of text content. The multiple content phrases may be constructed by using information from at least one of: market data, sales data, product performance data, education data, or analysis and forecast data. In specific examples, the multiple content phrases are constructed using at least one of: phrasing templates which arrange the text portions; custom language which provides defined language for the text portions; or human-determined weighting values which affect the selection of content used in the multiple content phrases. In other examples, the multiple content phrases may be retrieved from a library of phrases, or from a third party entity who generates or provides such phrases.

Operation 1203 includes identifying multiple content phrases (candidate phrases) for possible output in a user interface. Each respective phrase of the identified multiple content phrases corresponds to one or more of the multiple pricing values. Such multiple content phrases may include at least one comment sentence for output via the user interface, where the comment sentence is based on a pricing value of a specific commodity type and commodity attribute. Such multiple content phrases may also include at least one interjection sentence for output via the user interface, where the interjection sentence is based on multiple pricing values of a specific commodity type and plurality of commodity attributes. Other forms of phrases may also be used.

Operation 1204 includes determining a relevance weight to provide an output of content, for each of the multiple content phrases (e.g., phrases generated in operation 1202 and identified in operation 1203). This relevance weight may be generated from properties associated with the customer and the respective one of the multiple content phrases, consistent with the weighting examples discussed above. For instance, the relevance weight for each of the identified multiple content phrases may be determined from values obtained from: ruleset data; customer segmentation data; customer model data; and pricing history data. Such ruleset data may define rules for output of the multiple content phrases, to identify whether the output of the multiple content phrases can occur in the user interface, and where the output of the multiple content phrases can occur in the user interface. Such customer segmentation data may provide data to affect a weight for each of the identified multiple content phrases, based on measured or modeled characteristics for a group of customers including the customer. Such customer model data may provide data to affect a weight for each of the identified multiple content phrases, based on measured or modeled characteristics for the customer. In a scenario where each of the multiple content phrases corresponds to a respective pricing product for the commodity, the pricing history data may provide data to affect a weight for each of the identified multiple content phrases, based on a pricing history of the respective pricing product for the commodity.

Operation 1205 includes determining applicable rules for output, for each of the multiple content phrases. In scenarios where the relevance weight uses ruleset data, these applicable rules may be applied as part of the relevance weight. In other examples, specific exclusion rules may be identified and applied.

Operation 1206 includes selecting a subset of the multiple content phrases for output in a user interface, based on the determined relevance weight for the multiple content phrases and the rules for output of the multiple content phrases. For instance, a rule may define that only a certain number of content phrases may be provided in each graphical user interface section (e.g., only one comment in a first section, only one interjection in a second section). This selection may involve selecting the n top weighted candidate content phrases.

Operation 1207 concludes the method 1200 by providing the selected subset of the multiple content phrases to a computing device, for output to the customer in the user interface. In various examples, the user interface is provided within: a website graphical user interface, a mobile app graphical user interface, an interactive voice output, or a messaging interface. In a specific example, providing the subset of the multiple content phrases for display in the user interface comprises providing the subset of the multiple content phrases to a client computing device via a RESTful (Representational state transfer) HTTP (Hypertext Transport Protocol) service.

A first implementation example of the method 1200 includes a non-transitory computer-readable storage medium comprising instructions to dynamically select content associated with a commodity for output to a customer in a user interface, such that the instructions, when executed, configure hardware processing circuitry of a computing system to perform the operations of method 1200 (and, related operations discussed herein).

A second implementation example of the method 1200 includes a computing system, comprising: memory storing pricing data comprising multiple pricing values associated with a commodity, and rules data comprising multiple rules for output of content in a user interface; and processing circuitry configured to dynamically select content associated with a commodity for output to a customer in a user interface, the processing circuitry configured to perform the operations of method 1200 (and, related operations discussed herein).

A third implementation example of the method 1200 includes a cloud computing system, comprising: a communications device configured to perform communications with a client computing system using at least one application programming interface; a memory device configured to store instructions; and processing circuitry configured to execute the instructions, wherein the instructions, when executed, cause the cloud computing system to host and operate the at least one application programming interface, the at one application programming interface to communicate data with the client computing system, to enable use of a graphical user interface at the client computing system with dynamically selected content, associated with a commodity, for output to a customer, according to the operations of method 1200 (and, related operations discussed herein).

A fourth implementation example of the method 1200 includes a server computing system, comprising: a communications device configured to perform communications with a client computing system via a website hosted by the server computing system; a memory device configured to store instructions; and processing circuitry configured to execute the instructions, wherein the instructions, when executed, cause the server computing system to host and operate the website, the website configured to provide a graphical user interface at the client computing system providing dynamically selected content, associated with a commodity, for output to a customer, according to the operations of method 1200 (and, related operations discussed herein).

A fifth implementation example of the method 1200 includes a client computing system, comprising: a communications device configured to perform communications with at least one application programming interface of a cloud computing system; a memory device configured to store instructions; and processing circuitry configured to execute the instructions, wherein the instructions, when executed, cause the client computing system to access the at least one application programming interface of the cloud computing system, to obtain data used with a graphical user interface provided according to the operations of method 1200 (and, related operations discussed herein).

A sixth implementation example of the method 1200 includes a client computing system, comprising: a display device; a memory device configured to store instructions; and processing circuitry configured to execute the instructions, wherein the instructions, when executed, cause the client computing system to present a graphical user interface via the display device, with dynamically selected content associated with a commodity, for output to a customer according to the operations of method 1200 (and, related operations discussed herein).

A seventh implementation example of the method 1200 includes an administrative user computing system, comprising: a storage device configured to store rules data; a memory device configured to store instructions; and processing circuitry configured to execute the instructions, wherein the instructions, when executed, cause the administrative computing system to access and modify the rules data, the rules data to modify configuration of a graphical user interface at the client computing system with dynamically selected content, associated with a commodity, for output to a customer, according to the operations of method 1200 (and, related operations discussed herein).

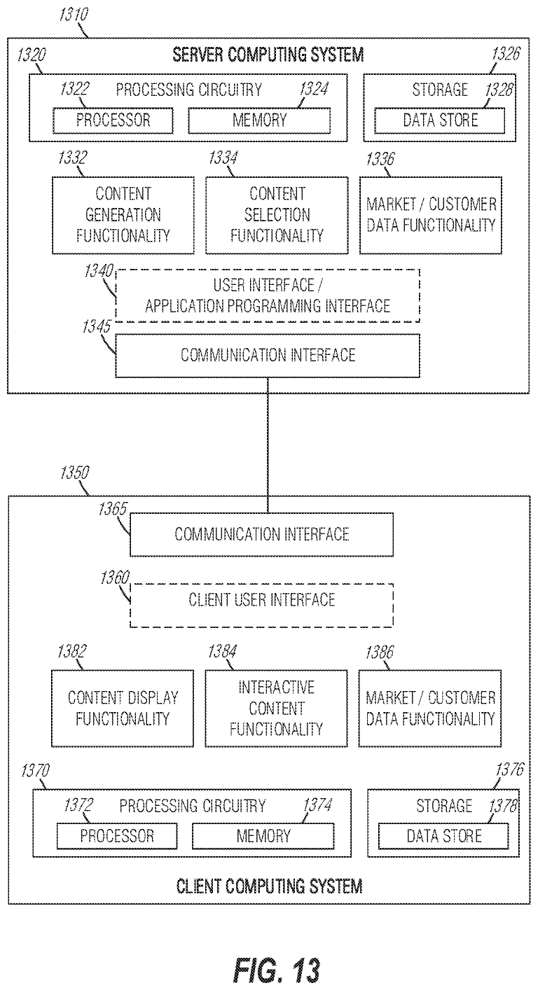

FIG. 13 illustrates a block diagram of an example server data processing system 1310 and an example client computing system 1350 for implementing the computing and processing techniques discussed herein, according to an example. For instance, the server computing system 1310 may provide features of the cloud service 111, content service deployment 120, content management system 130, and computing devices described thereto; the client computing system 1350 may provide features of the application user interface 140, the website user interface 150, and other client computing devices described thereto.

The computing systems 1310, 1350 may be operated by or embodied in a number of different computing platforms, such as in a server form factor, a workstation or personal computer form factor, a mobile computing device, etc., but are specifically illustrated with reference to server and client implementations. In some examples, the server system 1310 may be a networked device connected via a network (or combination of networks) to the client computing system 1350, with the server computing system operating an interface 1340 (in the form of a server-hosted user interface, or an application programming interface) that is communicatively coupled to the network with a communication interface 1345, and with the client computing system 1350 operating a client user interface 1360 that is communicatively coupled to the network with a communication interface 1365. The network may include local, short-range, or long-range networks, such as Bluetooth, cellular, IEEE 802.11 (Wi-Fi), or other wired or wireless networks.

The systems 1310, 1350 each include a processor 1322, 1372 and a memory 1324, 1374, which can be arranged as part of processing circuitry 1320, 1370. The processors 1322, 1372 respectively may be any single processor or group of processors that act cooperatively. The memory 1324, 1374 respectively may be any type of memory, including volatile or non-volatile memory. The memory 1324, 1374 on each respective system may include instructions (e.g., provided by storage 1326, 1376), which when executed by the processor 1322, 1372 cause the processor 1322, 1372 to implement the functional features described herein. This may include, for the server computing system 1310, content generation functionality 1332 (e.g., in connection with the sentence generator 420 of the content service deployment 120), content selection functionality 1334 (e.g., in connection with the sentence selector 450 of the content service deployment 120), market or customer data functionality 1336 (e.g., to retrieve and output pricing or customer information, such as sourced from a market data service 170 or a customer data service 160), or related processing features, to implement the functions or systems discussed above. This may include, for the client computing system 1350, content display functionality 1382 (e.g., to generate and output the user interfaces 140, 150), interactive content functionality 1384 (e.g., to receive and respond to interaction via user interface controls, commands, selections, etc., within the user interfaces 140, 150), market and customer data functionality 1386 (e.g., to provide selected pricing or customer information, sourced from the market data service 170 or the customer data service 160), or related processing features. This may also include the use or persisting of data with use of data stores (e.g., databases) 1328, 1378. Thus, it will be understood that the references to electronic operations in the systems 1310, 1350 or the processing circuitry 1320, 1370 may be performed by the respective processors 1322, 1372 or the circuitry 1320, 1370 as a whole. For example, the processors or circuitry may implement any of the features of the methods 300, 400, 1100 or functions described among the figures above, including those for operation of the user interfaces and application programming interfaces. The processors or circuitry may further provide (or obtain) data and commands to assist the processing and implementation using communication interfaces 1345, 1365.

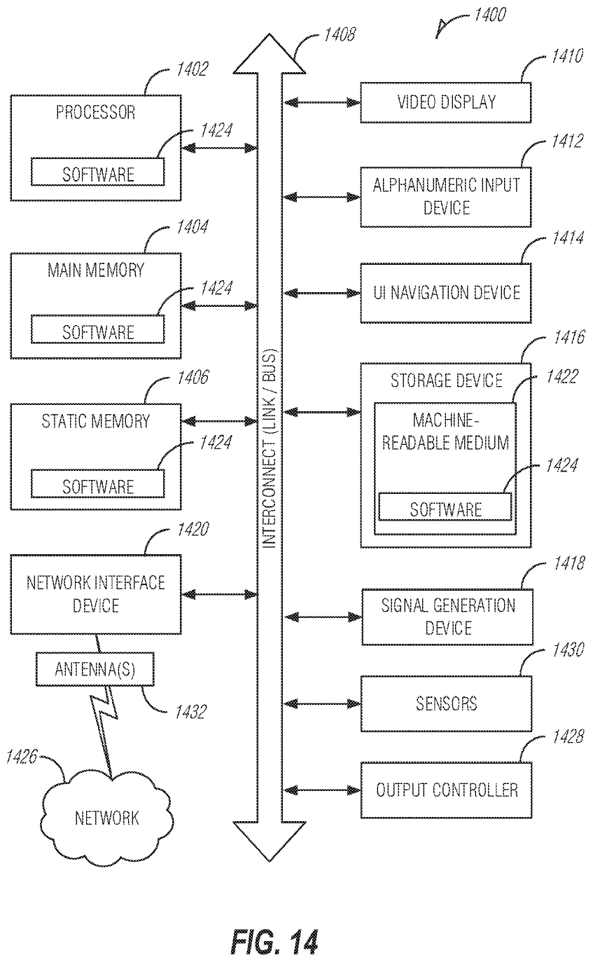

FIG. 14 illustrates a block diagram of an example computing system machine 1400 upon which any one or more of the techniques (e.g., methodologies) discussed herein may perform. Machine 1400 (e.g., computer system) may include a hardware processor 1402 (e.g., a central processing unit (CPU), a graphics processing unit (GPU), a hardware processor core, or any combination thereof), a main memory 1404 and a static memory 1406, connected via an interconnect 1408 (e.g., link or bus), as some or all of these components may constitute hardware for systems 110, 1310, 1350, or hardware to operate the services and subsystems 111, 120, 130, 160, 170 and related implementations discussed above.

Specific examples of main memory 1404 include Random Access Memory (RAM), and semiconductor memory devices, which may include, in some embodiments, storage locations in semiconductors such as registers. Specific examples of static memory 1406 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 1400 may further include a display device 1410, an input device 1412 (e.g., a keyboard), and a user interface (UI) navigation device 1414 (e.g., a mouse). In an example, the display device 1410, input device 1412 and UI navigation device 1414 may be a touch screen display. The machine 1400 may additionally include a mass storage device 1416 (e.g., drive unit), a signal generation device 1418 (e.g., a speaker), a network interface device 1420, and one or more sensors 1430, such as a global positioning system (GPS) sensor, compass, accelerometer, or some other sensor. The machine 1400 may include an output controller 1428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the hardware processor 1402 and/or instructions 1424 may comprise processing circuitry and/or transceiver circuitry.

The mass storage device 1416 may include a machine readable medium 1422 on which is stored one or more sets of data structures or instructions 1424 (e.g., software) embodying or utilized by any one or more of the techniques or functions described herein. The instructions 1424 may also reside, completely or at least partially, within the main memory 1404, within static memory 1406, or within the hardware processor 1402 during execution thereof by the machine 1400. In an example, one or any combination of the hardware processor 1402, the main memory 1404, the static memory 1406, or the mass storage device 1416 constitutes, in at least some embodiments, machine readable media.

Specific examples of machine readable media include, one or more of non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks. While the machine readable medium 1422 is illustrated as a single medium, the term “machine readable medium” includes, in at least some embodiments, a single medium or multiple media (e.g., a centralized or distributed database, and/or associated caches and servers) configured to store the one or more instructions 1424.

An apparatus of the machine 1400 includes, in at least some embodiments, one or more of a hardware processor 1402 (e.g., a central processing unit (CPU), a graphics processing unit (GPU), a hardware processor core, or any combination thereof), a main memory 1404 and a static memory 1406, sensors 1430, network interface device 1420, antennas 1432, a display device 1410, an input device 1412, a UI navigation device 1414, a mass storage device 1416, instructions 1424, a signal generation device 1418, and an output controller 1428. The apparatus is configured, in at least some embodiments, to perform one or more of the methods and/or operations disclosed herein. The apparatus is, in some examples, a component of the machine 1400 to perform one or more of the methods and/or operations disclosed herein, and/or to perform a portion of one or more of the methods and/or operations disclosed herein. In some examples, the apparatus includes, in some embodiments, a pin or other means to receive power. In some embodiments, the apparatus includes power conditioning hardware.

The term “machine readable medium” includes, in some embodiments, any medium that is capable of storing, encoding, or carrying instructions for execution by the machine 1400 and that cause the machine 1400 to perform any one or more of the techniques of the present disclosure, or that is capable of storing, encoding or carrying data structures used by or associated with such instructions. Non-limiting machine readable medium examples include solid-state memories, and optical and magnetic media. Specific examples of machine readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media includes non-transitory machine readable media. In some examples, machine readable media includes machine readable media that is not a transitory propagating signal.

The instructions 1424 are further transmitted or received, in at least some embodiments, over a communications network 1426 using a transmission medium via the network interface device 1420 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example embodiment, the network interface device 1420 includes one or more physical jacks (e.g., Ethernet, coaxial, or phone jacks) or one or more antennas to connect to the communications network 1426. In an example embodiment, the network interface device 1420 includes one or more antennas 1432 to wirelessly communicate using at least one of single-input multiple-output (SIMO), multiple-input multiple-output (MIMO), or multiple-input single-output (MISO) techniques. In some examples, the network interface device 1420 wirelessly communicates using Multiple User MIMO techniques. The term “transmission medium” shall be taken to include any intangible medium that is capable of storing, encoding or carrying instructions for execution by the machine 1400, and includes digital or analog communications signals or other intangible medium to facilitate communication of such software.

At least some example embodiments, as described herein, include, or operate on, logic or a number of components, modules, or mechanisms. Such components are tangible entities (e.g., hardware) capable of performing specified operations and are configured or arranged in a certain manner. In an example, circuits are arranged (e.g., internally or with respect to external entities such as other circuits) in a specified manner as a module. In an example, the whole or part of one or more computer systems (e.g., a standalone, client or server computer system) or one or more hardware processors are configured by firmware or software (e.g., instructions, an application portion, or an application) as a component that operates to perform specified operations. In an example, the software resides on a machine readable medium. In an example, the software, when executed by the underlying hardware of the component, causes the hardware to perform the specified operations.

Accordingly, such components are understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which components are temporarily configured, each of the modules need not be instantiated at any one moment in time. For example, where the components comprise a general-purpose hardware processor configured using software, in some embodiments, the general-purpose hardware processor is configured as respective different components at different times. Software accordingly configures a hardware processor, for example, to constitute a particular component at one instance of time and to constitute a different component at a different instance of time.

Some embodiments are implemented fully or partially in software and/or firmware. This software and/or firmware takes the form of instructions contained in or on a non-transitory computer-readable storage medium, in at least some embodiments. Those instructions are then read and executed by one or more hardware processors to enable performance of the operations described herein, in at least some embodiments. The instructions are in any suitable form, such as but not limited to source code, compiled code, interpreted code, executable code, static code, dynamic code, and the like. Such a computer-readable medium includes any tangible non-transitory medium for storing information in a form readable by one or more computers, such as but not limited to read only memory (ROM); random access memory (RAM); magnetic disk storage media; optical storage media; flash memory, etc.

Various embodiments may be implemented fully or partially in software and/or firmware. This software and/or firmware may take the form of instructions contained in or on a non-transitory computer-readable storage medium. Those instructions are then read and executed by one or more processors to enable performance of the operations described herein. The instructions are in any suitable form, such as but not limited to source code, compiled code, interpreted code, executable code, static code, dynamic code, and the like. Such a computer-readable medium includes, in at least some embodiments, any tangible non-transitory medium for storing information in a form readable by one or more computers, such as but not limited to read only memory (ROM); random access memory (RAM); magnetic disk storage media; optical storage media; flash memory, etc.

1. A non-transitory computer-readable storage medium comprising instructions to dynamically select content associated with a commodity for output to a customer in a user interface, wherein the instructions, when executed, configure hardware processing circuitry of a computing system to perform operations comprising:
obtaining multiple pricing values associated with a commodity;
identifying multiple content phrases, a respective one of the multiple content phrases corresponding to one or more of the multiple pricing values;
determining a relevance weight for each of the identified multiple content phrases, the relevance weight being generated from properties associated with the customer and the respective one of the multiple content phrases;
selecting a subset of the multiple content phrases for output in a user interface, based on the determined relevance weight for the multiple content phrases and rules for output of the multiple content phrases; and
providing the selected subset of the multiple content phrases to a computing device, for output to the customer in the user interface.

2.-9. (canceled)

10. The non-transitory computer-readable storage medium of claim 1, wherein the multiple pricing values are associated with respective expiration or execution dates associated with at least one of: a cash price, a futures contract price, an options contract price, a delivery contract price, or a pricing strategy price, for the commodity; and
wherein the commodity is an agricultural commodity provided from among: corn, soybeans, wheat, barley, rice, oats, oilseeds, cocoa, cotton, coffee, sugar, or products thereof.

11. The non-transitory computer-readable storage medium of claim 1, wherein the user interface is provided within: a website graphical user interface, a mobile app graphical user interface, an interactive voice output, or a messaging interface.

12. (canceled)

13. A computing system, comprising:
memory storing:
pricing data comprising multiple pricing values associated with a commodity; and
rules data comprising multiple rules for output of content in a user interface; and
processing circuitry configured to dynamically select content associated with a commodity for output to a customer in a user interface, the processing circuitry configured to perform operations to:
obtain multiple pricing values associated with a commodity;
identify multiple content phrases, a respective one of the multiple content phrases corresponding to one or more of the multiple pricing values;
determine a relevance weight for each of the identified multiple content phrases, the relevance weight being generated from properties associated with the customer and the respective one of the multiple content phrases;
select a subset of the multiple content phrases for output in a user interface, based on the determined relevance weight for the multiple content phrases and rules for output of the multiple content phrases; and
provide the selected subset of the multiple content phrases to a computing device, for output to the customer in the user interface.

14. The computing system of claim 13, the processing circuitry further configured to perform operations to:
generate the multiple content phrases from a combination of text portions, the text portions corresponding to pieces of text content;
wherein the multiple content phrases are constructed by using information from at least one of: market data, sales data, product performance data, education data, or analysis and forecast data.

15. The computing system of claim 14, wherein the multiple content phrases are constructed using at least one of:
phrasing templates which arrange the text portions;
custom language which provides defined language for the text portions; or
human-determined weighting values which affect the selection of content used in the multiple content phrases.

16. The computing system of claim 15, wherein the multiple content phrases comprise at least one of:
a comment sentence for output via the user interface, wherein the comment sentence is based on a pricing value of a specific commodity type and commodity attribute; or
an interjection sentence for output via the user interface, wherein the interjection sentence is based on multiple pricing values of a specific commodity type and plurality of commodity attributes.

17. The computing system of claim 13, wherein the relevance weight for each of the identified multiple content phrases is determined from values obtained from:
ruleset data;
customer segmentation data;
customer model data; and
pricing history data.

18. The computing system of claim 17, wherein the ruleset data defines rules for output of the multiple content phrases, to identify whether the output of the multiple content phrases can occur in the user interface, and where the output of the multiple content phrases can occur in the user interface.

19. The computing system of claim 17, wherein the customer segmentation data provides data to affect a weight for each of the identified multiple content phrases, based on measured or modeled characteristics for a group of customers including the customer.

20. The computing system of claim 17, wherein the customer model data provides data to affect a weight for each of the identified multiple content phrases, based on measured or modeled characteristics for the customer.

21. The computing system of claim 17, wherein each of the multiple content phrases corresponds to a respective pricing product for the commodity, wherein the pricing history data provides data to affect a weight for each of the identified multiple content phrases, based on a pricing history of the respective pricing product for the commodity.

22. The computing system of claim 13, wherein the multiple pricing values are associated with respective expiration or execution dates associated with at least one of: a cash price, a futures contract price, an options contract price, a delivery contract price, or a pricing strategy price, for the commodity; and
wherein the commodity is an agricultural commodity provided from among: corn, soybeans, wheat, barley, rice, oats, oilseeds, cocoa, cotton, coffee, sugar, or products thereof.

23. The computing system of claim 13, wherein the user interface is provided within: a website graphical user interface, a mobile app graphical user interface, an interactive voice output, or a messaging interface.

24. The computing system of claim 13, wherein providing the selected subset of the multiple content phrases for display in the user interface comprises providing the selected subset of the multiple content phrases to a client computing device via a RESTful (Representational state transfer) HTTP (Hypertext Transport Protocol) service.

25. A computer-implemented method for dynamically selecting content associated with a commodity for output to a customer in a user interface, the method comprising:
obtaining multiple pricing values associated with a commodity;
identifying multiple content phrases, a respective one of the multiple content phrases corresponding to one or more of the multiple pricing values;
determining a relevance weight for each of the identified multiple content phrases, the relevance weight being generated from properties associated with the customer and the respective one of the multiple content phrases;
selecting a subset of the multiple content phrases for output in a user interface, based on the determined relevance weight for the multiple content phrases and rules for output of the multiple content phrases; and
providing the selected subset of the multiple content phrases to a computing device, for output to the customer in the user interface.

26. The computer-implemented method of claim 25, the method further comprising:
generating the multiple content phrases from a combination of text portions, the text portions corresponding to pieces of text content;
wherein the multiple content phrases are constructed by using information from at least one of: market data, sales data, product performance data, education data, or analysis and forecast data.

27. The computer-implemented method of claim 26, wherein the multiple content phrases are constructed using at least one of:
phrasing templates which arrange the text portions;
custom language which provides defined language for the text portions; or
human-determined weighting values which affect the selection of content used in the multiple content phrases.

28. The computer-implemented method of claim 27, wherein the multiple content phrases comprise at least one of:
a comment sentence for output via the user interface, wherein the comment sentence is based on a pricing value of a specific commodity type and commodity attribute; or
an interjection sentence for output via the user interface, wherein the interjection sentence is based on multiple pricing values of a specific commodity type and plurality of commodity attributes.

29.-33. (canceled)

34. The computer-implemented method of claim 25, wherein the multiple pricing values are associated with respective expiration or execution dates associated with at least one of: a cash price, a futures contract price, an options contract price, a delivery contract price, or a pricing strategy price, for the commodity; and
wherein the commodity is an agricultural commodity provided from among: corn, soybeans, wheat, barley, rice, oats, oilseeds, cocoa, cotton, coffee, sugar, or products thereof.

35.-42. (canceled)
